(19) United States
(12) Patent Application Publication
(10) Pub. No.: US 2013/0090203 A1
(43) Pub. Date: Apr. 11, 2013

(54) DIFFERENTIAL TRANSMISSION FOR A WIND POWER INSTALLATION AND METHOD FOR OPERATION OF SAID DIFFERENTIAL TRANSMISSION

(71) Applicant: Gerald Hehenberger, Klagenfurt (AT)

(72) Inventor: Gerald Hehenberger, Klagenfurt (AT)

(73) Assignee: Laboratorie Francais Du Fractionnement Et Des Biotechnologies, Les Ulls (FR)

(21) Appl. No.: 13/704,360

(22) PCT Filed: Jun. 30, 2011
(86) PCT No.: PCT/EP2011/061081

§ 371 Date: Dec. 14, 2012

(30) Foreign Application Priority Data
Jul. 1, 2010 (AT) A1113/2010

(51) Int. Cl. F16H 48/34

(52) U.S. Cl. CPC F16H 48/34
USPC 475/5

(57) ABSTRACT

A differential transmission (4) for an energy generating installation, in particular for a wind power installation, has three input or output drives wherein a first input drive is connected to an input drive shaft (2) of the energy generating installation, an output drive is connected to a generator (13) which can be connected to a power supply system (9), and a second input drive is connected to an electrical machine (14, 8) as a differential drive (14). At least two machine-side frequency converter output stages (22) are connected to the electrical machine (14, 18). The electrical machine (14, 18) can therefore prevent the second input drive from rotating at an excessively high rotation speed in the event of failure of a machine-side frequency converter output stage (22), by electrical braking with the aid of at least one further machine-side frequency converter output stage (22).

The invention relates to a differential transmission for a power-generating installation, especially for a wind power installation, with three input and output drives, a first input drive being connected to a drive shaft of the power-generating installation, one output drive being connected to a generator that can be connected to an electrical power system, and a second input drive being connected to an electrical machine as a differential drive, and a method for operating the differential transmission.

The invention furthermore relates to a power-generating installation, especially a wind power installation, with one input drive shaft, a generator that can be connected to an electrical power system, and with a differential transmission with three input and output drives, a first input drive being connected to the input drive shaft, an output drive being connected to the generator, and a second input drive being connected to an electrical machine as a differential drive.

The invention finally also relates to a method for operating a differential transmission.

Wind power plants are becoming increasingly important as electricity-generating installations. For this reason, the percentage of power generation by wind is continually increasing. On the one hand, this in turn dictates new standards with respect to current quality and, on the other hand, a trend toward still larger wind power installations. At the same time, a trend in the direction of offshore wind power installations that requires installation sizes of at least 5 MW installed power can be recognized. Here, the availability of the installations acquires special importance due to high costs for infrastructure and maintenance or repair of wind power installations in the offshore domain.

The necessity for a variable rotor speed, on the one hand to increase the aerodynamic efficiency in the partial load range and on the other hand to control the torque in the drive line of the wind power installation, the latter for purposes of speed control of the rotor in combination with the rotor blade adjustment, is common to all installations. Therefore, wind power installations that meet this requirement by using variable-speed generator designs increasingly in the form of so-called permanent magnet-excited low voltage synchronous generators in combination with IGBT frequency converters are currently in use. This approach, however, has the disadvantage that (a) the wind power installations can be connected to the medium-voltage electrical power system only by means of transformers, and (b) the frequency converter that is necessary for the variable speed is very powerful and therefore a source of losses of efficiency. Alternatively, therefore, recently so-called differential drives are also being used that use separately-excited medium voltage synchronous generators connected to the medium voltage electrical power system in combination with a differential transmission and an auxiliary drive that preferably provides for a permanent magnet-excited synchronous machine in combination with a low-power IGBT frequency converter.

AT 507 395 A shows a differential system with an electrical servo drive with a permanent magnet-excited synchronous machine in combination with an IGBT frequency converter.

Due to the transmission ratios in the differential transmission, however, special precautions must be taken so that in, for example, not-stop of the power-generating installation, no damaging overspeeds, i.e., speeds above a given maximum value, occur on the differential system. For the most part, mechanical brakes that prevent overspeeds by braking of the, for example, differential drive are used for this purpose.

Therefore, the object of the invention is to take corresponding precautions in order to prevent an overspeed.

This object is achieved with a differential transmission with the features of Claim 1 and with a power-generating installation, especially a wind power installation, with the features of Claim 17.

This object is furthermore achieved with a method with the features of Claim 18.

In the invention, the electrical machine can prevent an overspeed of the second input drive when a machine-side frequency converter output stage fails by electrical braking using at least one other machine-side frequency converter output stage, as a result of which a mechanical brake is no longer needed.

Preferred embodiments of the invention are the subject matter of the dependent claims.

Preferred embodiments of the invention are described in detail below with reference to the attached drawings.

FIG. 1 shows a wind power installation according to the prior art with an electrical input drive consisting of a permanent-field synchronous generator and an IGBT frequency converter,

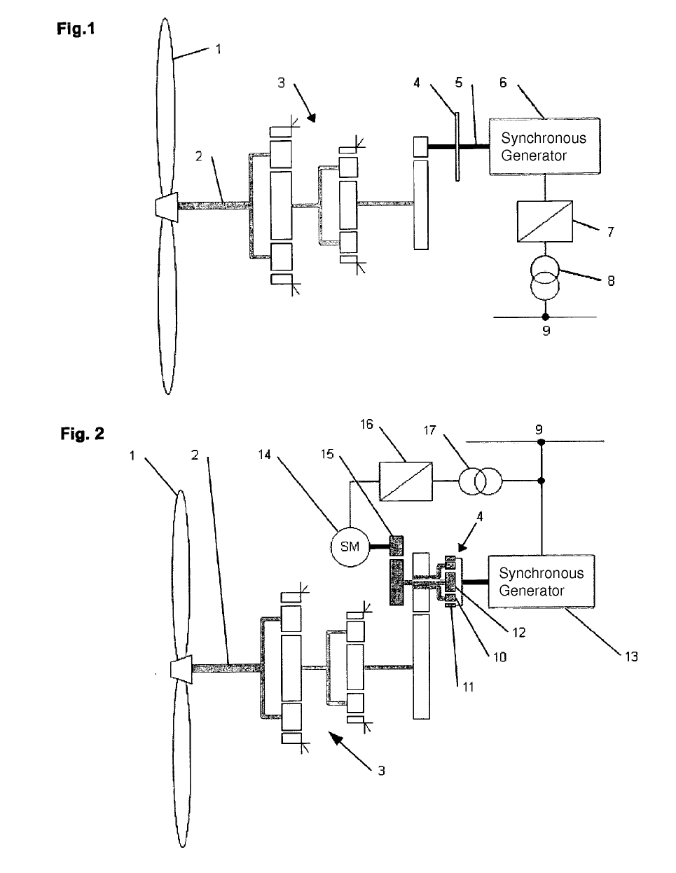

FIG. 2 shows the principle of a differential transmission with an electrical differential drive according to the prior art,

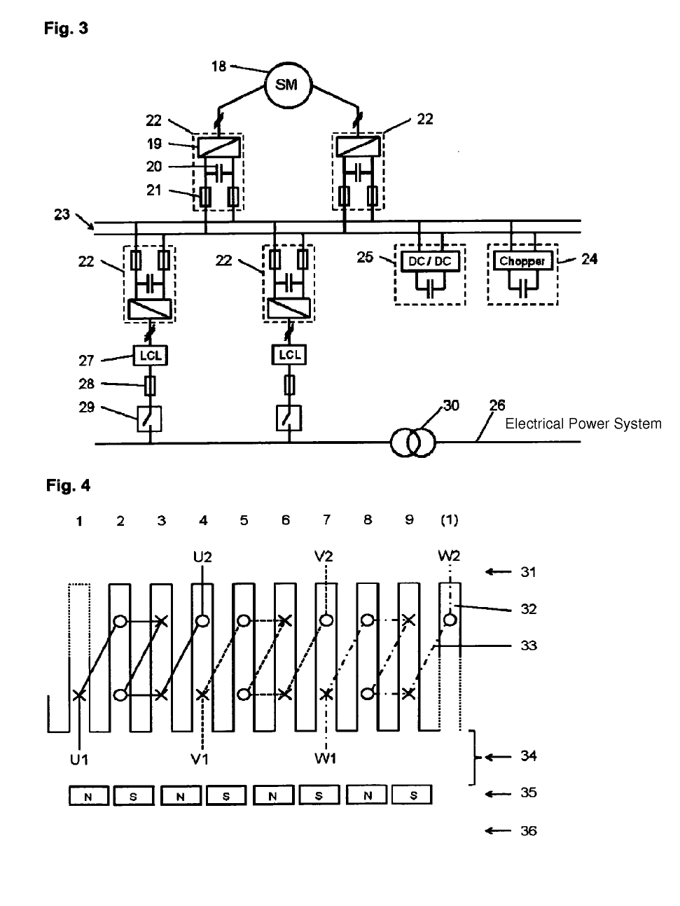

FIG. 3 shows the redundant structure of an electrical input drive,

FIG. 4 shows the fundamental structure of a two-layer, single-tooth winding,

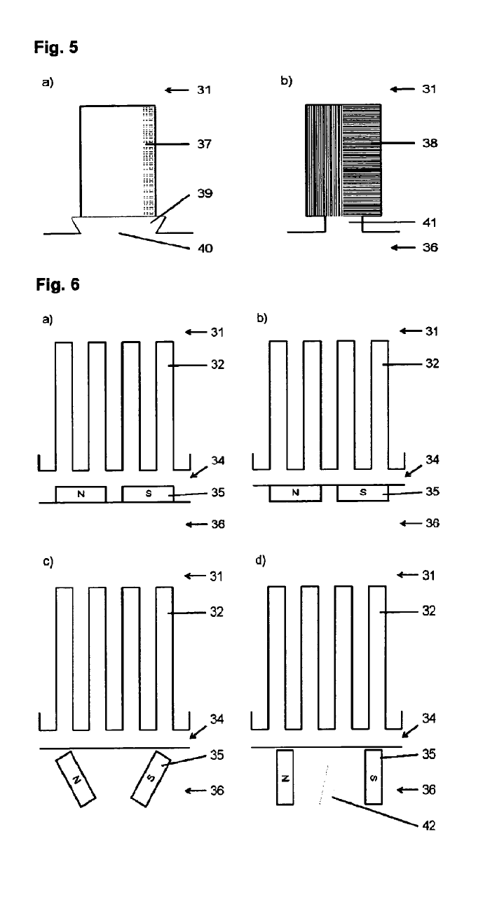

FIG. 5 shows different stator slot shapes of three-phase machines,

FIG. 6 shows different structural arrangements of the permanent magnets of permanent-field three-phase machines,

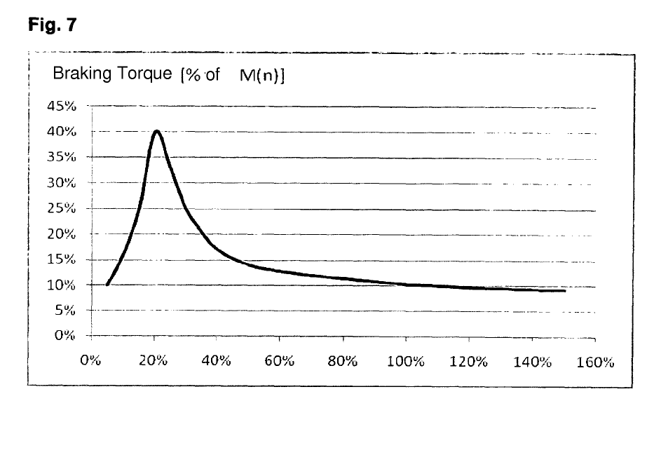

FIG. 7 shows by way of example the plot of the braking torque in an interwinding fault of the stator of a permanent-field synchronous machine with a single-tooth winding and embedded permanent magnets.

The output of the rotor of a wind power installation is computed from the following formula:

rotor output=rotor area power coefficient air density/2 wind speed3

the power coefficient being dependent on the high speed number (=ratio of the blade tip speed to the wind speed) of the rotor of the wind power installation. The rotor of a wind power installation is designed for an optimum power coefficient based on a high speed number that is to be established in the course of development (generally a value of between 7 and 9). For this reason, in the operation of the wind power installation in the partial load range, a correspondingly low speed can be set to ensure optimum aerodynamic efficiency.

FIG. 1 shows the principle of a variable-speed wind power installation according to the state of the art with an electrical input drive with a permanent-field synchronous generator and an IGBT frequency converter that are generally called high-speed full converter systems. A rotor 1 of the wind power installation that sits on an input drive shaft 2 for a main transmission 3 drives the main transmission 3. The main transmission 3 is a 3-stage transmission with two planetary stages and one spur gear stage. Between the main transmission 3 and the generator 6, there is an operating brake 4 and a clutch 5. The generator 6—preferably a permanent magnet-excited synchronous generator—is connected to a medium voltage electrical power system 9 via a frequency converter 7 and a transformer 8. In the case of a not-stop, generally the operating brake 4 is activated; it is designed such that it can stop the rotor 1 and the entire drive line with the main transmission 3 and generator 6.

FIG. 2 shows one possible principle of a differential system for a variable-speed wind power installation. The rotor 1 of the wind power installation that sits on the input drive shaft 2 for the main transmission 3 drives the main transmission 3. The main transmission 3 is a 3-stage transmission with two planetary stages and one spur gear stage. Between the main transmission 3 and the generator 13, there is a differential stage 4 that is driven by the main transmission 3 via a sun wheel 10 of the differential stage 4. The generator 13—preferably a separately-excited synchronous generator, which if necessary can also have a nominal voltage greater than 20 kV—is connected to an internal spur gear 11 of the differential stage 4 and is driven by it. A pinion 12 of the differential stage 4 is connected to a differential drive 14. The speed of the differential drive 14 is controlled in order, on the one hand, to ensure a constant speed of the generator 13 at a variable speed of the rotor 1 and, on the other hand, to control the torque in the complete drive line of the wind power installation. To increase the input speed for the differential drive 14, in the illustrated case a 2-stage differential transmission is chosen that provides a matching transmission stage 15 in the form of a spur gear stage between the differential stage 4 and the differential drive 14. The differential stage 4 and the matching transmission stage 15 thus form the 2-stage differential transmission. The differential drive 14 is a three-phase machine that is connected to the medium voltage electrical power system 9 via a frequency converter 16 and a transformer 17.

In the design of differential drives, however, important special cases must be examined. Thus, for example, a failure of the differential drive can entail serious damage. One example is an induced not-stop of the power-generating installation in nominal operation. Here, at the same time, the generator is separated from the electrical power system and the transferable torque in the drive line suddenly approaches zero. The speed of the rotor of the wind power installation in this case is preferably likewise adjusted very quickly against a speed equal to zero by a prompt re-setting of the rotor blade adjustment. Due to the relatively high mass inertia of the generator, the latter will, however, only slowly reduce its speed. In this way, to the extent the differential drive can at least partially maintain its torque without delay, an overspeed of the differential drive is inevitable.

For this reason, for example when using hydrostatic differential drives, there is a mechanical brake that when the differential drive fails reduces overspeeds that are damaging to the drive line. For this purpose, WO2004/109157 A1 shows a mechanical brake that acts directly on the generator shaft and thus can brake the generator accordingly.

Both the generator 6 according to FIG. 1 and also the differential drive 14 according to FIG. 2 are preferably permanent-field synchronous machines; however, the differential drive 14 can be dimensioned to be much smaller than the generator 6. The same applies analogously to the frequency converters of the two systems.

The power of the differential drive 14 is essentially proportional to the product of the percentage deviation of the rotor speed from its base speed (generally called “slip”) times the rotor power. Accordingly, a large speed range fundamentally requires a correspondingly large dimensioning of the differential drive 14. One possibility for expanding the speed range of the rotor of the wind power installation and thus raising the energy yield with uniform slip of the differential system is the use of the so-called field weakening range of, for example, a permanent magnet-excited synchronous three-phase machine as an electrical differential drive 14.

FIG. 3 shows the redundant structure of a variable-speed electrical machine. For example, the differential drive 14 of FIG. 2 is made as a permanent-field synchronous machine 18 (FIG. 3) with two electrically separate windings, generally three-phase windings. Permanent magnets are used in the rotor. It may be advantageous to execute the electrical machine not as an internal rotor, but as an external rotor, the stator then having the permanent magnets and the rotor having the parallel windings.

Two parallel IGBT full bridges 19 are connected to this synchronous machine 18; they can be controlled independently of one another with a controller, and in each case are provided with capacitors 20, and are linked to a DC intermediate circuit 23 via DC fuses 21. The DC fuses 21 are to be recommended so that in a short-circuit in a frequency converter output stage 22, the DC intermediate circuit is not likewise short-circuited and thus further operation of the system becomes impossible.

These frequency converter output stages 22, essentially preferably consisting of controlled IGBT full bridges 19, controllers, capacitors 20, current measurement and DC fuses 21, can be mounted with the required busbars/cabling on a common support plate that at the same time is part of the cooling body or is connected to it. The cooling especially of the IGBTs is preferably water cooling, but can also be designed as air cooling. The indicated support plate is preferably guided and attached in slide rails. If, moreover, the external current and coolant connections are made generally or even only partially pluggable, defective frequency converter output stages 22 in case of a fault can be promptly and easily changed.

The DC intermediate circuit 23 is the connecting element for the individual frequency converter output stages 22. To protect the frequency converter against overvoltage, here preferably a so-called brake chopper 24 with resistors is also connected. This brake chopper 24 can also dissipate excess energy in, for example, an electrical power system failure.

Moreover, for power-generating installations with differential systems, an energy storage device 25 is also to be recommended. This energy storage device 25 preferably consists essentially of supercaps that are connected to the DC intermediate circuit 23. In order to make the voltage level optimum or flexible for the operating range of these supercaps, they can be connected via DC/DC converters to the DC intermediate circuit 23.

Depending on the system management of the power-generating installation, the energy storage device 25 under certain circumstances can also assume the function of the brake chopper 24.

If the aforementioned capacitors 20 in the frequency converter output stages 22 are overdimensioned, in the ideal case the energy storage device 25 can thus also be replaced.

The same frequency converter output stages 22 are preferably used between the DC intermediate circuit 23 and the electrical power system 26. These frequency converter output stages 22, however, on the electrical power system side must perform functions other than the above-described machine-side frequency converter output stages.

In the case of a differential system according to FIG. 2, it works both in the generator mode and the motor mode. That is to say, in motor operation, the machine-side frequency converter output stages 22 work as inverters for speed/torque control, and the electrical power system-side frequency converter output stages 22 work as rectifier modules. Accordingly, suitable controller software is necessary. In generator operation, the frequency converter works as already described above for the high-speed full converter systems.

In summary, for the controller software of the frequency converter output stages 22, this means that preferably all described functions are stored on the controller hardware and can be automatically retrieved according to the required function. This can be dictated or coordinated by a higher-level control.

So that the electrical power system-side frequency converter output stages 22 meet the current quality criteria that are required by the electrical power system operator, there can be a so-called LCL filter 27. For reasons of redundancy, it can be made separately for each electrical power system-side frequency converter output stages 22. The same applies for fuses 28 and circuit breakers 29. Alternatively, LCL filters 27, fuses 28, and circuit breakers 29 can be made single. Thus, there is, however, no redundancy for these components. Moreover, the electrical power system-side IGBT full bridges would have to be triggered in parallel; in practice, this often leads to unfavorable compensating currents between the frequency converter output stages 22 and thus necessitates not insignificant power reductions.

The embodiment in FIG. 3 shows two parallel power lines with one winding of the electrical machine 18 each and one machine-side, i.e., generator-side, and one electrical power system-side frequency converter output stage 22, one LCL filter 27, one fuse 28, and one circuit breaker 29. A larger number of parallel power lines can also be implemented, however. Moreover, it is feasible but not necessary to keep the number of winding executions of the synchronous machine 18 the same as the number of machine-side frequency converter output stages 22. Preferably, however, the number of winding executions will be selected to be not smaller than the number of machine-side frequency converter output stages 22 in order to avoid the above-described problem of the IGBT full bridges that are to be triggered in parallel.

In order to meet increased demands with reference to the reactive current to be delivered into the electrical power system, for example, the number of frequency converter output stages 22 on the electrical power system side can be higher than on the machine side. For different reasons, however, it can also be efficient to select the number of frequency converter output stages 22 on the machine side to be higher than on the electrical power system side.

Due to the redundant execution of the winding of the synchronous machine 18 and of the frequency converter output stages 22 that is shown in FIG. 3, in the failure of one output stage always at least 50% of the nominal torque is present as braking torque that may even be briefly exceeded according to the thermal design. Here, in addition, a possible reduction of the IGBT clock frequency helps. Preferably, the brake chopper 24 and/or the energy storage device 25 can then be designed such that the excess energy can be stored. The indicated 50% of the nominal torque is generally sufficient to prevent an overspeed of the differential drive with which the use of a mechanical brake is no longer necessary.

If it is assumed that a short-circuit occurs in a frequency converter output stage 22 much more often than an interwinding fault, multiple execution of the winding can be omitted without great risk.

In an interwinding fault or a short-circuit of the winding by a short-circuit in one of the machine-side IGBT full bridges, for the permanent-field synchronous machines, a large braking torque arises whose size is dependent on the execution of the machines. Thus, in the example according to FIG. 3, one power line would be driven, but the other power line would be braked and further operation of the installation would not be easily possible.

In a short-circuit in one of the frequency converter output stages 22, the short-circuited frequency converter output stage 22 could also be separated from the connected winding of the generator via a fuse or a circuit breaker.

In permanent magnet-excited synchronous machines, a large field weakening range can be implemented when a) the magnetic flux linkage between the rotor and stator has high asymmetry between the longitudinal axis and the transversal axis and/or b) the leakage inductance in the stator is large (large longitudinal inductance).

The two aforementioned properties can be revealed by design measures, and thus an enlarged field weakening range (up to 3 times the nominal speed) at operationally sufficient torque (up to 0.4 times the nominal torque) can be achieved.

High leakage inductances are achieved preferably by using single-tooth windings with an asymmetrical slot/pole pair ratio.

The single-tooth winding that makes it possible to produce motors with a low space requirement and high efficiency is characterized in that each winding coil surrounds exactly one stator tooth. In comparison, in a distributed winding, each winding coil always surrounds several stator teeth. The single-tooth winding can be made as a single-layer or two-layer winding. FIG. 4 shows by way of example a stator 31 that has been unwound in the plane of the drawings with a two-layer single-tooth winding 33 with nine slots 32 and one rotor 36 with four permanent magnet pole pairs 35. Stators 31 and rotors 36 are separated by the air gap 34.

In two electrically separate winding systems (the first winding has, for example, the index a, and the second winding has, for example, the index b), the spatial sequence of the three-phase winding (U, V, W) based on FIG. 4 would be, by way of example: Ua, Ub, Va, Vb, Wa, Wb.

For the number q of slots per pole (2*p) and the phase (m), generally the relationship q=Q/(2*p*m) applies, Q being the total number of stator slots. q is also called the hole number. Depending on the ratio Q/(2*p*m), an asymmetrical flux linkage between the rotor and stator arises. For the two-layer, single-tooth winding that is shown by way of example in FIG. 4, thus Q=9 and 2*p=8 apply. For a 3-phase system, m=3 and thus q=3/8.

The leakage inductance can be amplified by narrowed slot openings. FIG. 5a) shows a typical stator slot shape 37 as is used in distributed windings. The wide slot opening 40 is closed with a slot wedge 39. FIG. 5b) shows one possible stator slot shape 38 as can be used in single-tooth windings. The slot opening 41 is narrowed and need not necessarily be closed by a slot wedge 40, as shown in FIG. 5a. Dramatically narrowed slot openings are relatively problem-free in single-tooth windings since the windings can be introduced in the longitudinal direction of the slot.

An asymmetrical flux linkage between the rotor 36 and the stator 31 is also achieved by permanent magnets 35 that are inserted into the rotor 36 or even more dramatically by permanent magnets 35 that are embedded in the rotor 36. FIG. 6 schematically shows a detail of a rotor 36 that has been unwound into the plane of the drawing with different structural arrangements of the permanent magnets 35. FIG. 6a) shows the magnets 35 mounted on the rotor 31, FIG. 6b) shows magnets 35 inserted into the rotor 31, and FIGS. 6c) and 6d) show magnets 35 embedded in the rotor 31.

A further amplification of the asymmetrical flux linkage is achieved by so-called magnetic flux barriers that are suitably set in mechanical terms. FIG. 6d), for example, shows the arrangement of the magnetic flux barrier 42. The magnetic flux barriers 42 can be implemented by inserting a magnetically nonconductive material or, in the simplest case, by an empty space that has been produced by punching-out.

A permanent magnet-excited synchronous machine that is equipped with electrically separate three-phase windings can continue to be operated with partial load in the case of a fault (phase-to-phase short-circuit). Here, it must be watched that the short-circuited winding generates a braking torque. This braking torque is much smaller at high leakage inductance (as described above).

FIG. 7 shows, by way of example, the plot of the braking torque that is produced by an interwinding fault in % of the nominal torque depending on the speed of the synchronous machine. Here, at roughly 20% of the nominal speed, a peak can be recognized that, however, when the speed rises or falls can be skipped in terms of control engineering, i.e., can be quickly traversed. In the other speed ranges, the torque adjusts itself at roughly 10% of the nominal torque. The behavior of the braking torque shown here can deviate more or less from the illustrated values for altered synchronous machine parameters.

If, in the example shown, an installation configuration with two parallel frequency converter output stages is assumed, the power-generating installation can continue to be operated for the most part with roughly 45% of the nominal torque of the installation.

Since, for example, wind power installations are operated over long time intervals in the partial load range, there is a loss of energy yield only in the operating range with more than 45% of the nominal torque. Here, adaptations can be undertaken in order to temporarily achieve a higher power output in part with increased operating speed at the torque that is limited to 45% in this case. At an average annual wind speed at the hub height of 7.5 m/s with a Rayleigh distribution (this covers a large part of the windy regions that can be commercially exploited worldwide), statistically the loss of energy yield is only roughly ⅓ of the energy yield that can be achieved in a completely serviceable installation.

Fundamentally, it is conceivable in the invention for the system to be overdimensioned to the extent there are one or more additional power lines, as a result of which more than 100% of the power that is required in normal operation is made available by the sum of all power lines. In the case in which one power line fails, its power can be taken over by a power line that has not yet been used or can be distributed among the other power lines that are not fully used in normal operation. This is especially advantageous when the generator is the differential drive of the power-generating installation, since the power lines in this case can be dimensioned to be relatively small and therefore are favorable.

Another advantage of the above-described single-tooth winding is that the fault case (phase-to-phase short-circuit) is very improbable since the contact of different phases in one slot is very greatly reduced compared to the distributed winding (FIG. 4). In the single-layer, single-tooth winding, there is no contact of the different phases at all in a slot since only one winding (one phase) is ever placed in one slot.

The described embodiments are only one example and are used preferably in wind power installations, but can likewise be implemented in technically similar applications. This applies, among others, to hydroelectric stations for use of river and sea flows. For this application, the same basic assumptions as for wind power installations apply, specifically variable flow velocity. The input drive shaft in these cases is driven directly or indirectly by the facilities that are driven by the flow medium, for example water.

1. Differential transmission (4) for a power-generating installation, especially for a wind power installation, with three input and output drives, a first input drive being connected to one input drive shaft (2) of the power-generating installation, one output drive being connected to a generator (13) that can be connected to an electrical power system (9), and a second input drive being connected to an electrical machine (14, 18) as a differential drive (14), characterized in that at least two machine-side frequency converter output stages (22) are connected to the electrical machine (14, 18).

2. Differential transmission (4) according to claim 1, wherein the electrical machine (14, 18) has at least two electrically separate windings, of which each is connected to at least one generator-side frequency converter output stage (22).

3. Differential transmission (4) according to claim 1, wherein the winding or windings is or are made as a single-tooth winding or windings.

4. Differential transmission (4) according to claim 1, characterized by at least two electrical power system-side frequency converter output stages (22).

5. Differential transmission (4) according to claim 1, wherein the generator (6, 14, 18) is a permanent magnet-excited synchronous machine.

6. Differential transmission (4) according to claim 1, wherein the frequency converter output stages (22) have IGBT full bridges (19).

7. Differential transmission (4) according to claim 6, wherein there are fuses (21) between the IGBT full bridges (19) and a DC intermediate circuit (23).

8. Differential transmission (4) according to claim 1, wherein the frequency converter output stages (22) have IGBT full bridges (19), capacitors (20), controllers, and fuses (21) that are jointly mounted on a support plate with a cooling body.

9. Differential transmission (4) according to claim 7, wherein the electrical connection between the frequency converter output stages (22) and the DC intermediate circuit (23) is pluggable.

10. Differential transmission (4) according to claim 3, wherein the permanent magnet-excited synchronous machine has embedded permanent magnets.

11. Differential transmission (4) according to claim 1, wherein there is a fuse or a circuit breaker between one winding and one frequency converter output stage (22) that is connected to it.

12. Differential transmission (4) according to claim 1, wherein there are one or more additional power lines, as a result of which more than 100% of the power that is required in normal operation can be made available by the sum of all power lines.

13. Differential transmission (4) according to claim 1, wherein the number of frequency converter output stages (22) provided on the generator side and the number of the frequency converter output stages (22) provided on the electrical power system side are different.

14. Differential transmission (4) according to claim 1, wherein to store the braking energy, an energy storage device (25), for example supercaps, is connected to a DC intermediate circuit (23).

15. Differential transmission (4) according to claim 1, wherein to store the braking energy, a brake chopper (24) is connected to a DC intermediate circuit (23).

16. Differential transmission (4) according to claim 1, wherein the electrical machine (14, 18) has an asymmetrical slot/pole pair ratio.

17. Power-generating installation, especially a wind power installation, with one input drive shaft (2), a generator (13) that can be connected to an electrical power system (9), and with a differential transmission with three input and output drives, a first input drive being connected to the drive shaft (2), an output drive being connected to the generator (13), and a second input drive being connected to an electrical machine as a differential drive (14), wherein at least two machine-side frequency converter output stages (22) are connected to the electrical machine (14, 18).

18. Method for operating a differential transmission (4) according to claim 1, wherein the electrical machine (14, 18) prevents an overspeed of the second input drive when a machine-side frequency converter output stage (22) fails by electrical braking using at least one other machine-side frequency converter output stage (22).

19. Method according to claim 18, wherein the electrical machine (14, 18) prevents an overspeed of the second input drive when one of at least two electrically separate windings fails by electrical braking using at least one other electrically separate winding.

20. Method according to claim 18, wherein electrical braking energy is stored in an energy storage device (25), for example supercaps.

21. Method according to claim 18, wherein electrical braking energy is stored in a brake chopper (24).
